(19) United States
(12) Patent Application Publication
(10) Pub. No.: US 2026/0141720 A1
(43) Pub. Date: May 21, 2026

(54) METHOD AND COMPUTER EQUIPMENT FOR MONITORING BUILDING SETTLEMENT AND STORAGE MEDIUM

(71) Applicants: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(72) Inventors: Nan JIN, Shenzhen (CN); Zhisen TAN, Shenzhen (CN); Tiandong CHEN, Shenzhen (CN); Zhongqi SHI, Shenzhen (CN); Qingrui YUE, Shenzhen (CN); Yanbing ZHOU, Shenzhen (CN)

(73) Assignees: SHENZHEN TECHNOLOGY INSTITUTE OF URBAN PUBLIC SAFETY, Shenzhen (CN); SHENZHEN SCIENCE AND TECHNOLOGY INSTITUTE OF URBAN SAFETY DEVELOPMENT, Shenzhen (CN)

(21) Appl. No.: 19/449,325

(22) Filed: Jan. 14, 2026

Related U.S. Application Data
(63) Continuation-in-part of application No. PCT/CN2025/070192, filed on Jan. 2, 2025.

(30) Foreign Application Priority Data
Jan. 8, 2024 (CN) 202410022462.7

(51) Int. Cl. G06V 20/40; G06V 20/64

(52) U.S. Cl. CPC G06V 20/46; G06V 20/64

(57) ABSTRACT

A method for monitoring building settlement includes: obtaining a central settlement pixel time history signal based on a central monitoring video, determining a scaling factor based on the central settlement pixel time history signal, obtaining an overall settlement pixel time history signal based on the overall monitoring video, and obtaining the settlement time history signal of the target building based on the scaling factor and the overall settlement pixel time history signal.

### CROSS-REFERENCE TO RELATED APPLICATIONS

This application is a continuation application of International Application No. PCT/CN2025/070192, filed on Jan. 2, 2025, which claims priority to Chinese Patent Application No. 202410022462.7, filed on Jan. 8, 2024. All of the aforementioned applications are incorporated herein by reference in their entireties.

### TECHNICAL FIELD

The present application relates to the technical field of static settlement monitoring, and in particular relates to a method and a computer equipment for monitoring building settlement and a storage medium.

### BACKGROUND

Vision-based static settlement monitoring technology utilizes cameras or camera systems to monitor whether buildings or structures are settling. This technology has advantages such as high measurement accuracy, long monitoring distance, no need for direct contact with the object being measured, and low monitoring cost. Compared with traditional measurement methods, it has a wider range of applications and technological advantages. However, when applied to actual building structure settlement monitoring, vision-based static settlement monitoring technology requires the calculation of physical quantity conversion parameters (scaling factors). Currently, the calculation of these parameters is not precise enough, resulting in low accuracy in building settlement measurement.

The above content is only used to help understand the technical solution of the present application and does not represent an admission that the above content is prior art.

### SUMMARY

The main objective of the present application is to provide a method and a computer equipment for monitoring building settlement and a storage medium, so as to obtain an accurate scaling factor and thereby improve the accuracy of building settlement monitoring.

To achieve the above objectives, the present application provides a method for monitoring building settlement, and the method includes:
obtaining a central settlement pixel time history signal based on a central monitoring video, the central monitoring video is a video taken with a preset marker as a center of a field of view;
determining a scaling factor based on the central settlement pixel time history signal;
framing an overall monitoring video to obtain an overall frame set, frames in the overall frame set are provided in a chronological order, and the overall monitoring video is a video taken with a building as the center of the field of view;
obtaining the frames in the overall frame set sequentially as an overall tracking template, and removing the overall tracking template from the overall frame set to obtain an overall matching video;
normalizing the overall tracking template to obtain a plurality of normalized overall templates and normalizing the overall matching video to obtain a plurality of normalized overall videos;
determining a plurality of overall mapping matrices based on the plurality of normalized overall templates and the plurality of normalized overall videos;
selecting a maximum value of each of the plurality of overall mapping matrices to obtain a second maximum value set, and obtaining an overall settlement pixel time history signal based on the second maximum value set; and
obtaining a settlement time history signal of a target building based on the scaling factor and the overall settlement pixel time history signal.

In addition, to achieve the above objectives, the present application further provides a computer equipment for monitoring building settlement, the computer equipment for monitoring building settlement includes a building settlement monitoring device, a memory, a processor and a computer program stored in the memory and executable on the processor, and the building settlement monitoring device is configured to implement the method for monitoring building settlement as described above. The computer equipment for monitoring building settlement includes:
a center signal acquisition module, configured to obtain a central settlement pixel time history signal based on a central monitoring video, the central monitoring video is a video taken with a preset marker as a center of a field of view;
a scaling factor determination module, configured to determine a scaling factor based on the central settlement pixel time history signal;
an overall signal module, configured to obtain an overall settlement pixel time history signal based on an overall monitoring video, the overall monitoring video is a video taken with a building as the center of the field of view; and
a target signal module, configured to obtain a settlement time history signal of the target building based on the scaling factor and the overall settlement pixel time history signal.

In addition, to achieve the above objectives, the present application further provides a computer-readable storage medium, a computer program is stored on the computer-readable storage medium, the computer program, when executed by a processor, implements the method for monitoring building settlement as described above.

The technical solution of the present application is as follows: based on the central monitoring video, the central settlement pixel time history signal is obtained; then, a scaling factor is determined based on the central settlement pixel time history signal; next, based on the overall monitoring video, the overall settlement pixel time history signal is obtained; finally, the settlement time history signal of the target building is obtained based on the scaling factor and the overall settlement pixel time history signal. The present application obtains the central settlement pixel time history signal by analyzing videos taken with a preset marker as the center of view and obtains the overall settlement pixel time history signal by analyzing videos taken with the building as the center of view. The scaling factor is obtained from the central settlement pixel time history signal, achieving high-precision calibration of the scaling factor. Then, the settlement time history signal of the target building is obtained by combining the scaling factor and the overall settlement pixel time history signal, improving the accuracy of building settlement monitoring and achieving precise monitoring of building settlement.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the embodiments of the present application or the technical solutions in the related art, the following briefly introduces the drawings required for use in the embodiments or the description of the related art. Obviously, for those skilled in the art, other drawings can be obtained based on these drawings without any creative work.

FIG. 1 is a structural schematic diagram of a hardware operating environment involved in a computer equipment for monitoring building settlement according to an embodiment of the present application.

FIG. 2 is a flowchart of a method for monitoring building settlement according to an embodiment of the present application.

FIG. 3 is a flowchart of the method for monitoring building settlement according to an embodiment of the present application.

FIG. 4 is a flowchart of the method for monitoring building settlement according to an embodiment of the present application.

FIG. 5 is a flowchart of the method for monitoring building settlement according to an embodiment of the present application.

FIG. 6 is a flowchart of the method for monitoring building settlement according to an embodiment of the present application.

FIG. 7 is a flowchart of the method for monitoring building settlement according to an embodiment of the present application.

FIG. 8 is a flowchart of the method for monitoring building settlement according to an embodiment of the present application.

FIG. 9 is a schematic diagram of the computer equipment for monitoring building settlement according to an embodiment of the present application.

The realization of the present application will be further explained in conjunction with the embodiments and with reference to the accompanying drawings.

### DETAILED DESCRIPTION OF THE EMBODIMENTS

It should be understood that the specific embodiments described herein are for illustrative purposes only and are not intended to limit the scope of the present application.

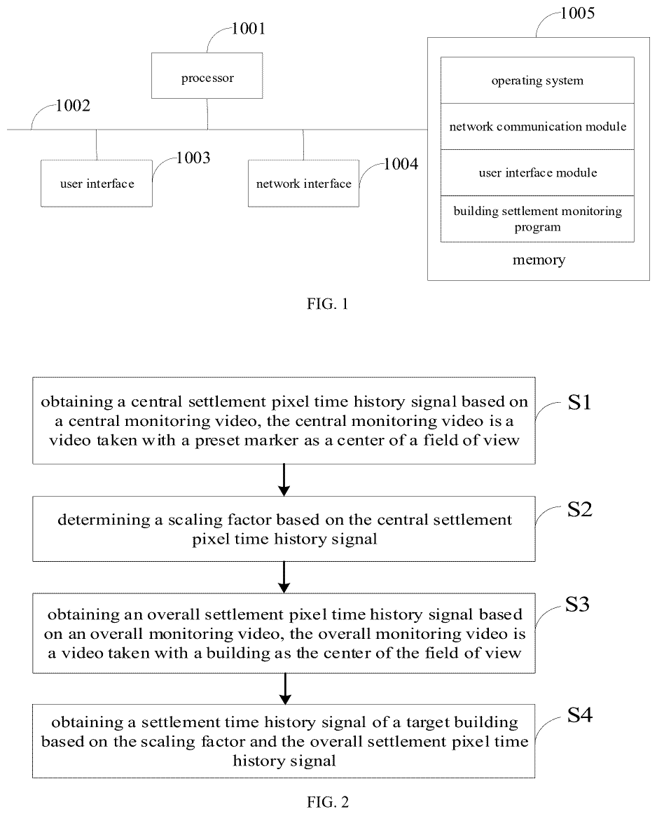

As shown in FIG. 1, which is a structural schematic diagram of a hardware operating environment involved in a computer equipment for monitoring building settlement according to an embodiment of the present application.

As shown in FIG. 1, the computer equipment for monitoring building settlement may include: a processor 1001, such as a central processing unit (CPU), a communication bus 1002, a user interface 1003, a network interface 1004, and a memory 1005. The communication bus 1002 is used to enable communication between these components. The user interface 1003 may include a display screen and an input unit such as a keyboard; the user interface 1003 may also include standard wired and wireless interfaces. The network interface 1004 may include standard wired and wireless interfaces, such as a wireless-fidelity (Wi-Fi) interface. The memory 1005 may be high-speed random access memory (RAM) or stable non-volatile memory (NVM), such as a disk drive. The memory 1005 may also be a storage device independent of the aforementioned processor 1001.

Those skilled in the art will understand that the structure shown in FIG. 1 does not constitute a limitation on the computer equipment for monitoring building settlement, and may include more or fewer components than shown, or combine certain components, or have different component arrangements.

As shown in FIG. 1, the memory 1005, which serves as a storage medium, may include an operating system, a network communication module, a user interface module, and a building settlement monitoring program.

In the computer equipment for monitoring building settlement shown in FIG. 1, the network interface 1004 is used for data communication with the network server; the user interface 1003 is used for data interaction with the user; the processor 1001 and the memory 1005 in the computer equipment for monitoring building settlement of the present application can be set in the computer equipment for monitoring building settlement. The computer equipment for monitoring building settlement calls the building settlement monitoring program stored in the memory 1005 through the processor 1001 and executes the method for monitoring building settlement provided in the embodiment of the present application.

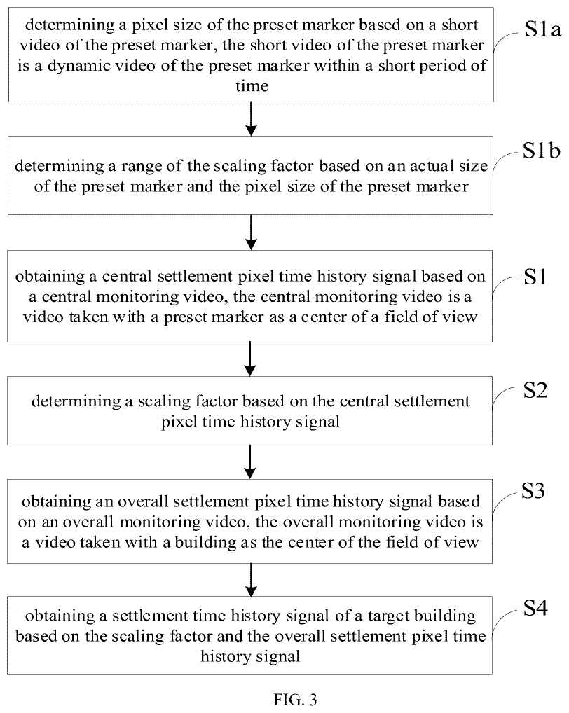

The present application provides a method for monitoring building settlement. As shown in FIG. 2, which is a flowchart of the method for monitoring building settlement according to an embodiment of the present application.

In the embodiment, the method for monitoring building settlement includes Step S1 to Step S4.

Step S1, obtaining a central settlement pixel time history signal based on a central monitoring video, the central monitoring video is a video taken with a preset marker as a center of a field of view.

It should be noted that the execution subject of the method in the embodiment can be a computing service device with data processing, network communication, and program execution functions, such as a mobile phone, tablet computer, or personal computer, or other electronic devices capable of performing the same or similar functions. The method for monitoring building settlement provided in the embodiment and the following embodiments will be described here using the aforementioned computer equipment for monitoring building settlement.

In an embodiment, the central monitoring video refers to the video taken with a preset marker as the center of the camera's field of view and the camera at a short distance from the preset marker (compared to the distance between the building and the camera in the overall monitoring video). The camera's field of view refers to the range of view that the camera can monitor at its current position and angle (i.e., the range that the lens can cover). The central settlement pixel time history signal refers to the pixel time history signal of the settlement change of the preset marker.

Furthermore, by recording and observing changes in markers, the stability and safety of buildings can be analyzed and predicted. In practical applications, different preset markers can be set according to different building structure types and building materials.

By analyzing the video captured with the preset marker as the center of the camera's field of view, the pixel time history signal of the settlement change of the preset marker is obtained, which is beneficial for obtaining the accurate scaling factor in the subsequent process, thereby improving the efficiency and effectiveness of building settlement monitoring.

Step S2, determining a scaling factor based on the central settlement pixel time history signal.

In an embodiment, the scaling factor is a physical quantity conversion parameter used in calculating settlement monitoring of actual building structures. Compared to traditional building monitoring methods, the method can use camera to detect building settlement by calculating the scaling factor, eliminating the need for direct contact with the object being measured, thus increasing monitoring distance and reducing monitoring costs.

Furthermore, based on the central settlement pixel time history signal, a scaling factor is determined, making building settlement monitoring more accurate.

Step S3, obtaining an overall settlement pixel time history signal based on an overall monitoring video, the overall monitoring video is a video taken with a building as the center of the field of view.

In an embodiment, the overall monitoring video is a video taken with the building as the center of the field of view (the building is provided with the preset markers), and the overall settlement pixel time history signal refers to the pixel time history signal of the settlement change of the building (the building is provided with the preset markers).

Furthermore, by analyzing videos taken with the building as the center of view, the pixel time history signal of the building's settlement change is obtained, which facilitates subsequent prediction and further analysis of building settlement.

Step S4, obtaining a settlement time history signal of a target building based on the scaling factor and the overall settlement pixel time history signal.

In an embodiment, based on the precise scaling factor and the pixel time history signal of the building's settlement change, a more precise pixel time history signal of the building's settlement change (settlement time history signal of the target building) can be determined. By analyzing the settlement time history signal of the target building, the precise building settlement situation can be obtained, thereby achieving accurate monitoring of building settlement.

Furthermore, the settlement time history signal of the target building can be expressed by the formula:

$$f ( t ) = Δ H ( t ) \times {SF}_{true}$$

Where f(t) represents the time history signal of the target building settlement, ΔH (t) is the time history signal of the preset marker, and SFₜᵣᵤₑ is the scaling factor.

The technical solution of the present application is as follows: based on the central monitoring video, the central settlement pixel time history signal is obtained; then, a scaling factor is determined based on the central settlement pixel time history signal; next, based on the overall monitoring video, the overall settlement pixel time history signal is obtained; finally, the settlement time history signal of the target building is obtained based on the scaling factor and the overall settlement pixel time history signal. The present application obtains the central settlement pixel time history signal by analyzing videos taken with a preset marker as the center of view and obtains the overall settlement pixel time history signal by analyzing videos taken with the building as the center of view. The scaling factor is obtained from the central settlement pixel time history signal, achieving high-precision calibration of the scaling factor. Then, the settlement time history signal of the target building is obtained by combining the scaling factor and the overall settlement pixel time history signal, improving the accuracy of building settlement monitoring and achieving precise monitoring of building settlement.

As shown in FIG. 3, which is a flowchart of the method for monitoring building settlement according to an embodiment of the present application.

Based on the above embodiment, in the embodiment, before step S1, the method further includes S1a to S1b.

S1a, determining a pixel size of the preset marker based on a short video of the preset marker, the short video of the preset marker is a dynamic video of the preset marker within a short period of time; and

S1b, determining a range of the scaling factor based on an actual size of the preset marker and the pixel size of the preset marker.

In an embodiment, a preset marker is attached to the surface of a building, and a short video of the marker is taken from the far end of the building. It should be noted that “short time” refers to a period of tens of seconds, which can be 10 seconds or 20 seconds, there is no specific limitation.

Furthermore, since the actual size of the preset marker is known, its pixel size can be measured based on the short video of the preset marker, and then the numerical range of the scaling factor can be determined according to the scaling factor formula. The specific calculation formula for the scaling factor is as follows:

$$SF = \frac{D}{I}$$

Where D is the actual size of the preset marker, I is the pixel size of the preset marker, and SF is the scaling factor.

Therefore, the numerical range of the scaling factor is determined as follows:

$${SF}_{lower} = \frac{D}{I + 1} , {SF}_{upper} = \frac{D}{I - 1}$$

Furthermore, based on the actual size and pixel size of the preset marker, the range of the scaling factor can be determined, which is beneficial for further determining the accurate value of the scaling factor, thereby improving the accuracy of building settlement monitoring.

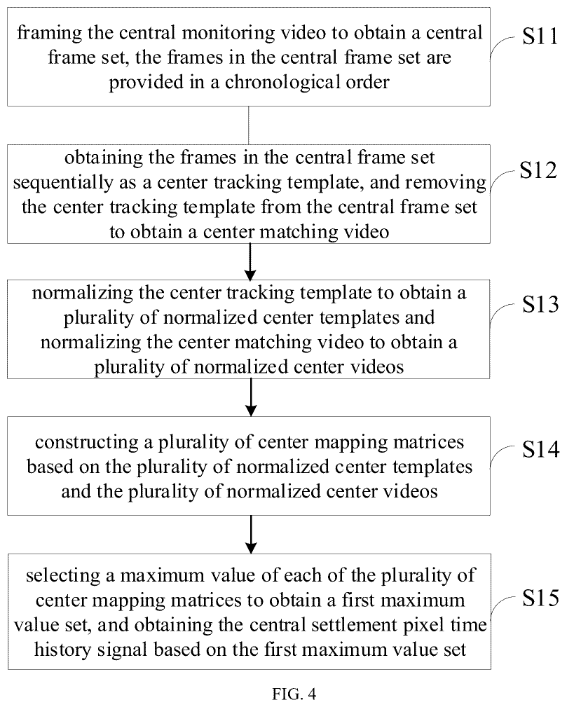

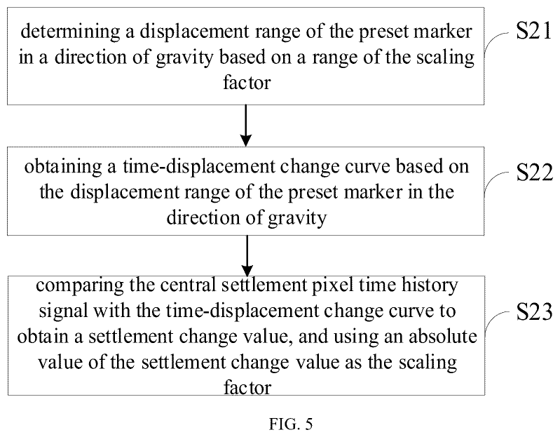

As shown in FIG. 4, which is a flowchart of the method for monitoring building settlement according to an embodiment of the present application.

Based on the above embodiment, in this embodiment, step S1 includes:
S11, framing the central monitoring video to obtain a central frame set, the frames in the central frame set are provided in chronological order;
S12, obtaining the frames in the central frame set sequentially as a center tracking template, and removing the center tracking template from the central frame set to obtain a center matching video;
S13, normalizing the center tracking template to obtain a plurality of normalized center templates and normalizing the center matching video to obtain a plurality of normalized center videos;
S14, constructing a plurality of center mapping matrices based on the plurality of normalized center templates and the plurality of normalized center videos; and
S15, selecting a maximum value of each of the plurality of center mapping matrices to obtain a first maximum value set, and obtaining the central settlement pixel time history signal based on the first maximum value set.

In an embodiment, step a, using a first frame of central monitoring video as the center tracking template T, and normalizing the center tracking template T and remaining frames I, T′ and I′ are obtained.

$${T}^{′} ( x , y ) = \frac{T ( x , y ) - \frac{1}{w \times h} {\sum }_{{x}^{″} , {y}^{″}} T ( {x}^{″} , {y}^{″} )}{\sqrt{{\sum }_{{x}^{″} , {y}^{″}} {T ( {x}^{″} , {y}^{″} )}^{2}}}$$

$${I}^{′} ( x , y ) = \frac{I ( x , y ) - \frac{1}{w \times h} {\sum }_{{x}^{″} , {y}^{″}} I ( {x}^{″} , {y}^{″} )}{\sqrt{{\sum }_{{x}^{″} , {y}^{″}} {I ( {x}^{″} , {y}^{″} )}^{2}}}$$

Step b, calculating a region mapping matrix of the preset marker R.

The normalized center template T′ slides from left to right and from top to bottom on the normalized center video I′. Each time the position is moved by one pixel, the mapping value at that position is calculated, and finally the region mapping matrix R of the preset marker is obtained.

$$R ( x , y ) = \frac{{\sum }_{x ′ , y ′} ( T ′ ( x ′ , y ′ ) I ′ ( x + x ′ , y + y ′ ) )}{\sqrt{{\sum }_{x ′ , y ′} T {′ ( x ′ , y ′ )}^{2} {\sum }_{x ′ , y ′} I {′ ( x + x ′ , y + y ′ )}^{2}}}$$

Where (x,y) is the coordinate of a point on the normalized center video; (x′, y′) is the coordinate of the image of the normalized center template; T(x,y) is the center tracking template, and a point (x,y) on the mapping matrix R(x,y) represents the correlation between the image sub-block in the normalized center video I′ with (x,y) as the upper left corner point, and the image sub-block with the same size as the image of the center tracking template T(x,y) and T(x,y).

Step c, selecting a position of a maximum value of the region mapping matrix as a matching result, and repeating the Step a to Step c for all frames in the center monitoring video, and obtaining the central settlement pixel time history signal f(t).

Furthermore, by normalizing each frame in the central monitoring video with the remaining frames to construct a plurality of mapping matrices, the central settlement pixel time history signal is obtained (the maximum value of each mapping matrix represents a point on the central settlement pixel time history signal), which facilitates the subsequent determination of the accurate value of the scaling factor and improves the accuracy of building settlement monitoring.

As shown in FIG. 5, which is a flowchart of the method for monitoring building settlement according to an embodiment of the present application.

Based on the above embodiment, in this embodiment, step S2 includes:
S21, determining a displacement range of the preset marker in a direction of gravity based on a range of the scaling factor;
S22, obtaining a time-displacement change curve based on the displacement range of the preset marker in the direction of gravity; and
S23, comparing the central settlement pixel time history signal with the time-displacement change curve to obtain a settlement change value, and using an absolute value of the settlement change value as the scaling factor.

In an embodiment, step S23 includes S231 and S232.

S231, traversing the central settlement pixel time history signal to obtain a time when an initial pixel change in the central settlement pixel time history signal is a preset pixel value, and using the initial pixel change as an initial moment; and
S232, determining a displacement amount corresponding to the initial moment in the time-displacement change curve, and using the displacement amount corresponding to the initial moment as the settlement change value, and using the absolute value of the settlement change value as the scaling factor.

In an embodiment, the preset marker is mounted at the preset calibration device, and the preset calibration device is then adhered to an attachment position of the original preset marker or a settlement monitoring point. The preset calibration device is a tool for measuring building settlement, ensuring the measured object remains horizontal or vertical, and providing high measurement accuracy.

In an embodiment, the scaling factor is determined according to Step A to Step C.

Step A, based on the numerical range of the scaling factor determining the displacement change of the preset marker controlled by the preset calibration device in the direction of gravity is [0, SFᵤₚₚₑᵣ−SF_{lower}].

Step B, controlling the preset calibration device to gradually fine-tune the displacement change of the preset marker in the direction of gravity, from 0 to SFᵤₚₚₑᵣ−SF_{lower}, and recording the time and displacement change value of each fine-tuning to obtain the time-displacement change curve.

Step C, traversing the initial moment Kt of the settlement occurrence in the central settlement pixel time history signal f(t) where the pixel change value is 1, and comparing the Kt with the time-displacement change curve to obtain the settlement change value of the Ki when 1 pixel change occurs. The absolute value of the settlement change value is the precise value of the scaling factor SFₜᵣᵤₑ.

Furthermore, the present application determines the displacement range of the preset marker in the direction of gravity by using a numerical range of the scaling factor, and then obtains a time-displacement change curve based on the displacement range. This enables the quantitative assessment of building settlement through pixel size changes in video images, improving the convenience and accuracy of building settlement monitoring. By using the absolute value of the displacement at the initial moment in the time-displacement change curve as a scaling factor, which makes the scaling factor more accurate, thereby making the subsequent settlement time history signal of the target building more precise and improving the accuracy of building settlement monitoring.

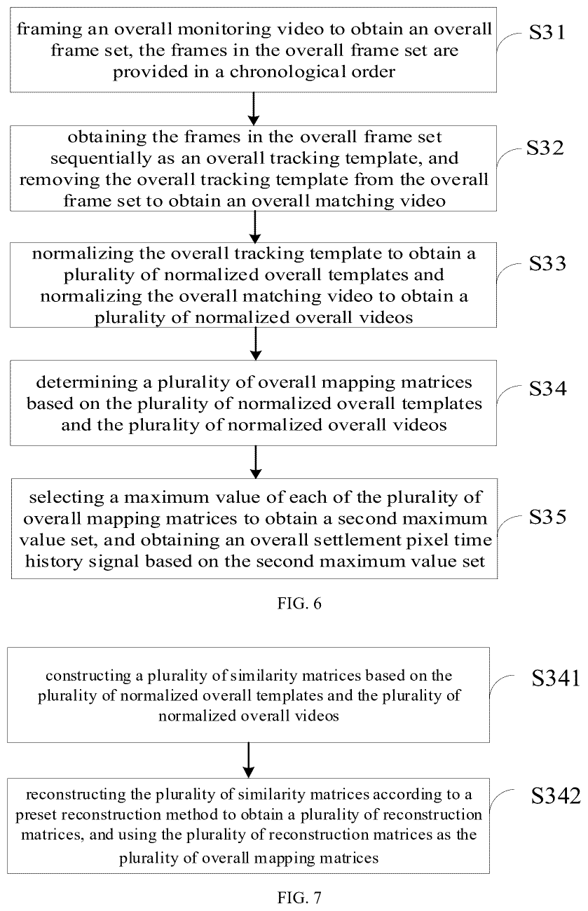

As shown in FIG. 6, which is a flowchart of the method for monitoring building settlement according to an embodiment of the present application.

Based on the above embodiment, in the embodiment, step S3 includes S31 and S35.

S31, framing an overall monitoring video to obtain an overall frame set, the frames in the overall frame set are provided in a chronological order;
S32, obtaining the frames in the overall frame set sequentially as an overall tracking template, and removing the overall tracking template from the overall frame set to obtain an overall matching video;
S33, normalizing the overall tracking template to obtain a plurality of normalized overall templates and normalizing the overall matching video to obtain a plurality of normalized overall videos;
S34, determining a plurality of overall mapping matrices based on the plurality of normalized overall templates and the plurality of normalized overall videos; and
S35, selecting a maximum value of each of the plurality of overall mapping matrices to obtain a second maximum value set, and obtaining an overall settlement pixel time history signal based on the second maximum value set.

In an embodiment, as shown in FIG. 7, FIG. 7 is flowchart of the method for monitoring building settlement according to an embodiment of the present application. Step S34 includes S341 to S342.

S341, constructing a plurality of similarity matrices based on the plurality of normalized overall templates and the plurality of normalized overall videos; and
S342, reconstructing the plurality of similarity matrices according to a preset reconstruction method to obtain a plurality of reconstruction matrices, and using the plurality of reconstruction matrices as the plurality of overall mapping matrices.

It should be noted that the overall monitoring video is a video taken of the building from a distance.

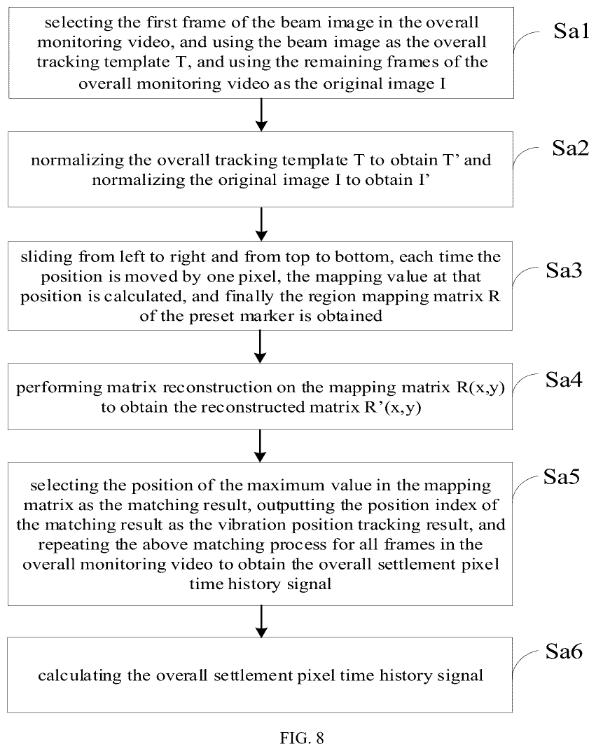

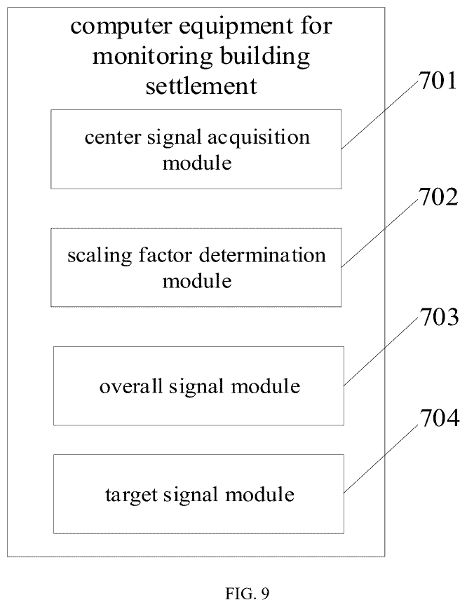

As shown in FIG. 8, FIG. 8 is a flowchart of the method for monitoring building settlement according to an embodiment of the present application. The steps to obtain the overall settlement pixel time history signal are as follows.

Sa1, selecting the first frame of the beam image in the overall monitoring video, and using the beam image as the overall tracking template T, and using the remaining frames of the overall monitoring video as the original image I.

Sa2, normalizing the overall tracking template T to obtain T′ and normalizing the original image I to obtain I′.

$${T}^{′} ( x , y ) = \frac{T ( x , y ) - \frac{1}{{w}_{1} \times {h}_{1}} {\sum }_{{x}^{″} , {y}^{″}} T ( {x}^{″} , {y}^{″} )}{\sqrt{{\sum }_{{x}^{″} , {y}^{″}} {T ( {x}^{″} , {y}^{″} )}^{2}}}$$

$${I}^{′} ( x , y ) = \frac{I ( x , y ) - \frac{1}{{w}_{2} \times {h}_{2}} {\sum }_{{x}^{″} , {y}^{″}} I ( {x}^{″} , {y}^{″} )}{\sqrt{{\sum }_{{x}^{″} , {y}^{″}} {I ( {x}^{″} , {y}^{″} )}^{2}}}$$

Where w₁ is the width of the overall tracking template, and h₁ is the height of the overall tracking template, w₂ is the width of the original image and h₂ is the height of the original image, T′ is the normalized overall tracking template and I′ is the normalized original image.

Step Sa3, sliding from left to right and from top to bottom, each time the position is moved by one pixel, the mapping value at that position is calculated, and finally the region mapping matrix R of the preset marker is obtained.

$$R ( x , y ) = \frac{{\sum }_{x ′ , y ′} ( {T}^{′} ( {x}^{′} , {y}^{′} ) {I}^{′} ( x + {x}^{′} , y + {y}^{′} ) )}{\sqrt{{\sum }_{x ′ , y ′} {{T}^{′} ( {x}^{′} , {y}^{′} )}^{2} {\sum }_{x ′ , y ′} {{I}^{′} ( x + {x}^{′} , y + {y}^{′} )}^{2}}}$$

Where, (x,y) is the coordinate of a point on the normalized overall video; (x′,y′) is the coordinate of the image of the overall tracking template; T(x,y) is the image of the overall tracking template with size w×h; a point (x,y) on the mapping matrix R(x,y) represents the correlation between the image sub-block in the normalized overall video I′ with (x,y) as the top left corner and the same size as the image of the overall tracking template T(x,y) and T(x,y).

Step Sa4, performing matrix reconstruction on the mapping matrix R(x,y) to obtain the reconstructed matrix R′ (x,y).
(1) Decomposing the coordinates (x,y) into integer parts×0, y0 and fractional parts dx, dy, the following relationship can be obtained:

$$x = {x}_{0} + dx , y = {y}_{0} + dy$$

(2) Taking 16 adjacent pixels centered at (x0, y0) and labeling them as I (xᵢ, yᵢ), where i, j=0, 1, 2, 3.
(3) Reconstructing the mapping matrix:

$${R}^{′} ( x , y ) = {\sum }_{i = 0}^{3} {\sum }_{j = 0}^{3} R ( x , y ) H ( i - dx ) H ( dy - j )$$

$$H ( t ) = \{ \begin{matrix}( a + 2 ) {\vert t \vert}^{3} - ( a + 3 ) {\vert t \vert}^{2} + 1 , & 0 \leq \vert t \vert < 1 \\ a {\vert t \vert}^{3} - 5 a {\vert t \vert}^{2} + 8 a \vert t \vert - 4 a , & 1 \leq \vert t \vert < 2 \\ 0 , & \vert t \vert \geq 2\end{matrix} ,$$

where a is a parameter to be determined

Step Sa5, selecting the position of the maximum value in the mapping matrix as the matching result, outputting the position index of the matching result as the vibration position tracking result, and repeating the above matching process for all frames in the overall monitoring video to obtain the overall settlement pixel time history signal.

Step Sa6, calculating the overall settlement pixel time history signal.

$$\{ \begin{matrix}Δ {H}_{i} = {H}_{i + 1} - {H}_{i} \\ Δ {L}_{i} = {L}_{i + 1} - {L}_{i}\end{matrix} , i = 1 , 2 , … ( n - 1 )$$

Where n is the quantity of image frames, Hi is height position of the vibration position tracking result output from the i-th image, and Li is the width position of the vibration position tracking result output from the i-th image.

In the embodiment, by normalizing each frame of the overall monitoring video with the remaining frames to construct the plurality of mapping matrices, the overall settlement pixel time history signal is obtained (the maximum value of each mapping matrix represents a point on the overall settlement pixel time history signal), thus improving the accuracy of the overall settlement pixel time history signal and consequently improving the accuracy of building settlement monitoring. By constructing similar matrices and reconstructing the matrices, the overall mapping matrix becomes more accurate, further improving the accuracy of the overall settlement pixel time history signal and consequently improving the accuracy of building settlement monitoring.

The technical solution of the present application is as follows: based on the central monitoring video, the central settlement pixel time history signal is obtained; then, a scaling factor is determined based on the central settlement pixel time history signal; next, based on the overall monitoring video, the overall settlement pixel time history signal is obtained; finally, the settlement time history signal of the target building is obtained based on the scaling factor and the overall settlement pixel time history signal. The present application obtains the central settlement pixel time history signal by analyzing videos taken with a preset marker as the center of view and obtains the overall settlement pixel time history signal by analyzing videos taken with the building as the center of view. The scaling factor is obtained from the central settlement pixel time history signal, achieving high-precision calibration of the scaling factor. Then, the settlement time history signal of the target building is obtained by combining the scaling factor and the overall settlement pixel time history signal, improving the accuracy of building settlement monitoring and achieving precise monitoring of building settlement.

Furthermore, the present application also proposes a storage medium storing a building settlement monitoring program, which, when executed by a processor, implements the steps of the method for monitoring building settlement described above.

As shown in FIG. 9, which is a schematic diagram of the computer equipment for monitoring building settlement according to an embodiment of the present application.

The computer equipment for monitoring building settlement includes: a center signal acquisition module 701, a scaling factor determination module 702, an overall signal module 703 and a target signal module 704.

The center signal acquisition module 701 is configured to obtain a central settlement pixel time history signal based on a central monitoring video, the central monitoring video is a video taken with a preset marker as a center of a field of view.

The scaling factor determination module 702 is configured to determine a scaling factor based on the central settlement pixel time history signal.

The overall signal module 703 is configured to obtain an overall settlement pixel time history signal based on an overall monitoring video, the overall monitoring video is a video taken with a building as the center of the field of view.

The target signal module 704 is configured to obtain a settlement time history signal of the target building based on the scaling factor and the overall settlement pixel time history signal.

The central signal acquisition module 701 includes a central framing unit, a center matching unit, a center normalization unit, a center mapping unit, and a central signal unit.

The central framing unit is configured to frame the central monitoring video to obtain a central frame set, the frames in the central frame set are provided in chronological order.

The center matching unit is configured to obtain the frames in the central frame set sequentially as a center tracking template, and remove the center tracking template from the central frame set to obtain a center matching video.

The center normalization unit is configured to normalize the center tracking template to obtain a plurality of normalized center templates and normalize the center matching video to obtain a plurality of normalized center videos.

The center mapping unit is configured to construct a plurality of center mapping matrices based on the plurality of normalized center templates and the plurality of normalized center videos.

The central signal unit is configured to select a maximum value of each of the plurality of center mapping matrices to obtain a first maximum value set, and obtain the central settlement pixel time history signal based on the first maximum value set.

The scaling factor determination module 702 includes a displacement determination unit, a curve determination unit, and a scaling factor determination unit.

The displacement determination unit is configured to determine a displacement range of the preset marker in a direction of gravity based on a range of the scaling factor.

The curve determination unit is configured to obtain a time-displacement change curve based on the displacement range of the preset marker in the direction of gravity.

The scaling factor determination unit is configured to compare the central settlement pixel time history signal with the time-displacement change curve to obtain a settlement change value, and use an absolute value of the settlement change value as the scaling factor.

The overall signal module 703 includes an overall frame segmentation unit, an overall matching unit, an overall normalization unit, an overall mapping unit, and an overall signal unit.

The overall frame segmentation unit is configured to frame the overall monitoring video to obtain an overall frame set, the frames in the overall frame set are provided in chronological order, and the overall monitoring video is a video taken with a building as the center of the field of view.

The overall matching unit is configured to obtain the frames in the overall frame set sequentially as an overall tracking template, and remove the overall tracking template from the overall frame set to obtain an overall matching video.

The overall normalization unit is configured to normalize the overall tracking template to obtain a plurality of normalized overall templates and normalize the overall matching video to obtain a plurality of normalized overall videos.

The overall mapping unit is configured to determine a plurality of overall mapping matrices based on the plurality of normalized overall templates and the plurality of normalized overall videos.

The overall signal unit is configured to select a maximum value of each of the plurality of overall mapping matrices to obtain a second maximum value set, and obtain the overall settlement pixel time history signal based on the second maximum value set.

In an embodiment, the center signal acquisition module 701 is further configured to determine a pixel size of the preset marker based on a short video of the preset marker, the short video of the preset marker is a dynamic video of the preset marker within a short period of time; and determine a range of the scaling factor based on an actual size of the preset marker and the pixel size of the preset marker.

In an embodiment, the scaling factor determination module 702 is further configured to traverse the central settlement pixel time history signal to obtain a time when an initial pixel change in the central settlement pixel time history signal is a preset pixel value, and use the initial pixel change as an initial moment; and determine a displacement amount corresponding to the initial moment in the time-displacement change curve, and use the displacement amount corresponding to the initial moment as the settlement change value, and use the absolute value of the settlement change value as the scaling factor.

In an embodiment, the overall signal module 703 is further configured to construct a plurality of similarity matrices based on the plurality of normalized overall templates and the plurality of normalized overall videos; and reconstruct the plurality of similarity matrices according to a preset reconstruction method to obtain a plurality of reconstruction matrices, and use the plurality of reconstruction matrices as the plurality of overall mapping matrices.

The technical solution of the present application is as follows: based on the central monitoring video, the central settlement pixel time history signal is obtained; then, a scaling factor is determined based on the central settlement pixel time history signal; next, based on the overall monitoring video, the overall settlement pixel time history signal is obtained; finally, the settlement time history signal of the target building is obtained based on the scaling factor and the overall settlement pixel time history signal. The present application obtains the central settlement pixel time history signal by analyzing videos taken with a preset marker as the center of view and obtains the overall settlement pixel time history signal by analyzing videos taken with the building as the center of view. The scaling factor is obtained from the central settlement pixel time history signal, achieving high-precision calibration of the scaling factor. Then, the settlement time history signal of the target building is obtained by combining the scaling factor and the overall settlement pixel time history signal, improving the accuracy of building settlement monitoring and achieving precise monitoring of building settlement.

The computer equipment for monitoring building settlement of the present application can be found in the above-described method embodiments, and will not be repeated here.

It should be noted that, in the present application, the terms “comprising”, “including” or any other variations thereof are intended to cover non-exclusive inclusion, such that a process, method, article, or system that comprises a list of elements includes not only those elements but also other elements not expressly listed, or elements inherent to such a process, method, article, or system. Unless otherwise specified, an element defined by the phrase “comprising one . . . ” does not exclude the presence of other identical elements in the process, method, article, or system that includes that element.

In the present application are for descriptive purposes only and do not represent the superiority or inferiority of the embodiments.

Through the above description of the embodiments, those skilled in the art can clearly understand that the methods of the above embodiments can be implemented by means of software plus necessary general-purpose hardware platforms. Of course, they can also be implemented by hardware, but in many cases the former is a better implementation method. Based on this understanding, the technical solution of the present application, in essence, or the part that contributes to the prior art, can be embodied in the form of a software product. This computer software product is stored in a storage medium (such as read-only memory/random access memory, magnetic disk, optical disk) and includes several instructions to cause a terminal device (which may be a mobile phone, computer, server, air conditioner, or network device, etc.) to execute the methods described in the various embodiments of the present application.

The above are merely optional embodiments of the present application and do not limit the patent scope of the present application. Any equivalent structural or procedural transformations made using the content of the specification and drawings of the present application, or direct or indirect applications in other related technical fields, are similarly included within the patent protection scope of the present application.

What is claimed is:

1. A method for monitoring building settlement, comprising:
obtaining a central settlement pixel time history signal based on a central monitoring video, wherein the central monitoring video is a video taken with a preset marker as a center of a field of view;
determining a scaling factor based on the central settlement pixel time history signal;
framing an overall monitoring video to obtain an overall frame set, wherein frames in the overall frame set are provided in a chronological order, and the overall monitoring video is a video taken with a building as the center of the field of view;
obtaining the frames in the overall frame set sequentially as an overall tracking template, and removing the overall tracking template from the overall frame set to obtain an overall matching video;
normalizing the overall tracking template to obtain a plurality of normalized overall templates and normalizing the overall matching video to obtain a plurality of normalized overall videos;
determining a plurality of overall mapping matrices based on the plurality of normalized overall templates and the plurality of normalized overall videos;
selecting a maximum value of each of the plurality of overall mapping matrices to obtain a second maximum value set, and obtaining an overall settlement pixel time history signal based on the second maximum value set; and
obtaining a settlement time history signal of a target building based on the scaling factor and the overall settlement pixel time history signal.

2. The method for monitoring building settlement according to claim 1, wherein before the obtaining the central settlement pixel time history signal based on the central monitoring video, the method further comprises:
determining a pixel size of the preset marker based on a short video of the preset marker, wherein the short video of the preset marker is a dynamic video of the preset marker within a short period of time; and
determining a range of the scaling factor based on an actual size of the preset marker and the pixel size of the preset marker.

3. The method for monitoring building settlement according to claim 2, wherein the obtaining the central settlement pixel time history signal based on the central monitoring video comprises:
framing the central monitoring video to obtain a central frame set, wherein frames in the central frame set are provided in chronological order;
obtaining the frames in the central frame set sequentially as a center tracking template, and removing the center tracking template from the central frame set to obtain a center matching video;
normalizing the center tracking template to obtain a plurality of normalized center templates and normalizing the center matching video to obtain a plurality of normalized center videos;
constructing a plurality of center mapping matrices based on the plurality of normalized center templates and the plurality of normalized center videos; and
selecting a maximum value of each of the plurality of center mapping matrices to obtain a first maximum value set, and obtaining the central settlement pixel time history signal based on the first maximum value set.

4. The method for monitoring building settlement according to claim 3, wherein the determining the scaling factor based on the central settlement pixel time history signal comprises:
determining a displacement range of the preset marker in a direction of gravity based on a range of the scaling factor;
obtaining a time-displacement change curve based on the displacement range of the preset marker in the direction of gravity; and
comparing the central settlement pixel time history signal with the time-displacement change curve to obtain a settlement change value, and using an absolute value of the settlement change value as the scaling factor.

5. The method for monitoring building settlement according to claim 4, wherein the comparing the central settlement pixel time history signal with the time-displacement change curve to obtain the settlement change value, and using the absolute value of the settlement change value as the scaling factor comprises:
traversing the central settlement pixel time history signal to obtain a time when an initial pixel change in the central settlement pixel time history signal is a preset pixel value, and using the initial pixel change as an initial moment; and
determining a displacement amount corresponding to the initial moment in the time-displacement change curve, and using the displacement amount corresponding to the initial moment as the settlement change value, and using the absolute value of the settlement change value as the scaling factor.

6. The method for monitoring building settlement according to claim 1, wherein determining the plurality of overall mapping matrices based on the plurality of normalized overall templates and the plurality of normalized overall videos comprises:
constructing a plurality of similarity matrices based on the plurality of normalized overall templates and the plurality of normalized overall videos; and
reconstructing the plurality of similarity matrices according to a preset reconstruction method to obtain a plurality of reconstruction matrices, and using the plurality of reconstruction matrices as the plurality of overall mapping matrices.

7. The method for monitoring building settlement according to claim 1, wherein obtaining the central settlement pixel time history signal based on the central monitoring video further comprises:
using a first frame of central monitoring video as the center tracking template, and normalizing the center tracking template and remaining frames;
calculating a region mapping matrix of the preset marker; and
selecting a position of a maximum value of the region mapping matrix as a matching result, and repeating the above steps for all frames in the central monitoring video to obtain the central settlement pixel time history signal.

8. The method for monitoring building settlement according to claim 5, wherein the preset marker is mounted at a preset calibration device, the preset calibration device is adhered to an attachment position of an original preset marker or a settlement monitoring point, and the preset calibration device is a building settlement measuring tool, and the preset calibration device is configured to keep a measured object horizontal or vertical.

9. A computer equipment for monitoring building settlement, comprising:
a building settlement monitoring device;
a memory;
a processor; and
a computer program stored in the memory and executable on the processor,
wherein the building settlement monitoring device is configured to implement a method for monitoring building settlement, the method comprises:
obtaining a central settlement pixel time history signal based on a central monitoring video, wherein the central monitoring video is a video taken with a preset marker as a center of a field of view;
determining a scaling factor based on the central settlement pixel time history signal;
obtaining an overall settlement pixel time history signal based on an overall monitoring video, wherein the overall monitoring video is a video taken with a building as the center of the field of view; and
obtaining a settlement time history signal of the target building based on the scaling factor and the overall settlement pixel time history signal;
wherein the computer equipment for monitoring building settlement comprising:
a center signal acquisition module, configured to obtain a central settlement pixel time history signal based on a central monitoring video, wherein the central monitoring video is a video taken with a preset marker as a center of a field of view;
a scaling factor determination module, configured to determine a scaling factor based on the central settlement pixel time history signal;
an overall signal module, configured to obtain an overall settlement pixel time history signal based on an overall monitoring video, wherein the overall monitoring video is a video taken with a building as the center of the field of view; and
a target signal module, configured to obtain a settlement time history signal of the target building based on the scaling factor and the overall settlement pixel time history signal;
wherein before the center signal acquisition module obtains the central settlement pixel time history signal based on the central monitoring video, the center signal acquisition module is further configured to:
determine a pixel size of the preset marker based on a short video of the preset marker, wherein the short video of the preset marker is a dynamic video of the preset marker within a short period of time; and
determine a range of the scaling factor based on an actual size of the preset marker and the pixel size of the preset marker;
wherein the central signal acquisition module is further configured to:
frame the central monitoring video to obtain a central frame set, wherein frames in the central frame set are provided in chronological order;
obtain the frames in the central frame set sequentially as a center tracking template, and remove the center tracking template from the central frame set to obtain a center matching video;
normalize the center tracking template to obtain a plurality of normalized center templates and normalize the center matching video to obtain a plurality of normalized center videos;
construct a plurality of center mapping matrices based on the plurality of normalized center templates and the plurality of normalized center videos; and
select a maximum value corresponding to each of the plurality of center mapping matrices to obtain a first maximum value set, and obtain the central settlement pixel time history signal based on the first maximum value set.

10. The computer equipment for monitoring building settlement according to claim 9, wherein the scaling factor determination module is further configured to:
determine a displacement range of the preset marker in a direction of gravity based on a range of the scaling factor;
obtain a time-displacement change curve based on the displacement range of the preset marker in the direction of gravity; and
compare the central settlement pixel time history signal with the time-displacement change curve to obtain a settlement change value, and use an absolute value of the settlement change value as the scaling factor.

11. The computer equipment for monitoring building settlement according to claim 10, wherein the scaling factor determination module is further configured to:
traverse the central settlement pixel time history signal to obtain a time when an initial pixel change in the central settlement pixel time history signal is a preset pixel value, and use the initial pixel change as an initial moment; and
determine a displacement amount corresponding to the initial moment in the time-displacement change curve, and use the displacement amount corresponding to the initial moment as the settlement change value, and use the absolute value of the settlement change value as the scaling factor.

12. The computer equipment for monitoring building settlement according to claim 9, wherein the overall signal module is further configured as follows:
frame the overall monitoring video to obtain an overall frame set, wherein the frames in the overall frame set are provided in chronological order, and the overall monitoring video is a video taken with a building as the center of the field of view;
obtain the frames in the overall frame set sequentially as an overall tracking template, and remove the overall tracking template from the overall frame set to obtain an overall matching video;
normalize the overall tracking template to obtain a plurality of normalized overall templates and normalize the overall matching video to obtain a plurality of normalized overall videos.

13. The computer equipment for monitoring building settlement according to claim 12, wherein the overall signal module is further configured as follows:
determine a plurality of overall mapping matrices based on the plurality of normalized overall templates and the plurality of normalized overall videos;
select a maximum value corresponding to each of the plurality of overall mapping matrices to obtain a second maximum value set, and obtain the overall settlement pixel time history signal based on the second maximum value set.

14. The computer equipment for monitoring building settlement according to claim 12, wherein the overall signal module is further configured as follows:
construct a plurality of similarity matrices based on the plurality of normalized overall templates and the plurality of normalized overall videos; and
reconstruct the plurality of similarity matrices according to a preset reconstruction method to obtain a plurality of reconstruction matrices, and use the plurality of reconstruction matrices as the plurality of overall mapping matrices.

15. The computer equipment for monitoring building settlement according to claim 9, wherein the central signal acquisition module is further configured to:
use a first frame of central monitoring video as the center tracking template, and normalize the center tracking template and remaining frames;
calculate a region mapping matrix of the preset marker; and
select a position of a maximum value of the region mapping matrix as a matching result, and repeat the above steps for all frames in the central monitoring video to obtain the central settlement pixel time history signal.

16. The computer equipment for monitoring building settlement according to claim 11, wherein the preset marker is mounted at a preset calibration device, the preset calibration device is adhered to an attachment position of an original preset marker or a settlement monitoring point, and the preset calibration device is a building settlement measuring tool configured to keep a measured object horizontal or vertical.
